(19) United States
(12) Patent Application Publication
(10) Pub. No.: US 2024/0319410 A1
(43) Pub. Date: Sep. 26, 2024

(54) STACK OF STERILE PEELABLE LENSES WITH LOW CREEP

(71) Applicant: Laminated Film LLC, Las Vegas, NV (US)

(72) Inventors: Stephen S. Wilson, Las Vegas, NV (US); Bart E. Wilson, Las Vegas, NV (US); Roger Cone, Las Vegas, NV (US)

(21) Appl. No.: 18/442,824

(22) Filed: Feb. 15, 2024

Related U.S. Application Data
(63) Continuation of application No. 17/823,413, filed on Aug. 30, 2022, now Pat. No. 11,933,943.
(60) Provisional application No. 63/365,909, filed on Jun. 6, 2022.

(51) Int. Cl. G02B 1/14; G02B 3/00

(52) U.S. Cl. CPC G02B 1/14; G02B 3/0062

(57) ABSTRACT

A method of manufacturing a sterile stack of peelable lenses includes coating a first lens (or stack of lenses) with a first adhesive coating, heating the first adhesive coating to initiate curing, exposing the first adhesive coating to ultraviolet light to continue curing, laminating a second lens (or stack of lenses) onto a surface of the first adhesive coating to produce a stack of lenses, coating the second lens with a second adhesive coating, heating the second adhesive coating to initiate curing, exposing the second adhesive coating to ultraviolet light to continue curing, laminating a third lens (or stack of lenses) onto a surface of the second adhesive coating to add the third lens to the stack of lenses, and exposing the stack of lenses to an electron beam to continue curing of the first and second adhesive coatings.

### CROSS-REFERENCE TO RELATED APPLICATIONS

This application is a continuation of U.S. application Ser. No. 17/823,413, filed Aug. 30, 2022, which relates to and claims the benefit of U.S. Provisional Application No. 63/365,909, filed Jun. 6, 2022 and entitled “Stack of Sterile Peelable Lenses with Low Creep,” the entire contents of which is expressly incorporated by reference herein.

### STATEMENT RE: FEDERALLY SPONSORED RESEARCH/DEVELOPMENT

Not Applicable

### BACKGROUND

Laminated, peelable, low peel strength (e.g., 30-80 gram-in) optical lens stacks may be employed in various contexts, such as in connection with protective eyewear or vehicle windshields. The low peel strength allows each lens to be removed from the stack one at a time. (As the peel strength increases above 600 gram-in, for example, the bond may be considered permanent.) As each lens is added to produce the stack, the heating and ultraviolet exposure that is used to cure each successive layer of adhesive may affect the already-cured adhesive layers as well. For instance, in a four-layer stack, the first layer may effectively be exposed to curing processes three or more times while the last layer is only exposed once. This can lead to under-cured layers which can lead to peel creep (i.e., increase in peel strength) over time and at normal storage temperatures (e.g., 59° F. to 86° F.).

### BRIEF SUMMARY

The present disclosure contemplates various methods for overcoming the above drawbacks accompanying the related art. One aspect of the embodiments of the disclosure is a method of manufacturing a stack of peelable lenses. The method may comprise coating a first lens with a first adhesive coating (e.g., comprising at least 30% solvent), heating the first adhesive coating to evaporate at least some solvent of the first adhesive coating and to initiate curing of the first adhesive coating, and, after the heating of the first adhesive coating, exposing the first adhesive coating to ultraviolet light to continue curing of the first adhesive coating. The method may further comprise, after the exposing of the first adhesive coating to ultraviolet light, laminating a second lens onto a surface of the first adhesive coating to produce a stack of lenses. The method may further comprise coating the second lens with a second adhesive coating (e.g., comprising at least 30% solvent), heating the second adhesive coating to evaporate at least some solvent of the second adhesive coating and to initiate curing of the second adhesive coating, and, after the heating of the second adhesive coating, exposing the second adhesive coating to ultraviolet light to continue curing of the second adhesive coating. The method may further comprise, after the exposing of the second adhesive coating to ultraviolet light, laminating a third lens onto a surface of the second adhesive coating to add the third lens to the stack of lenses. The method may further comprise, after the laminating of the third lens onto the surface of the second adhesive coating, exposing the stack of lenses to an electron beam to continue curing of the first adhesive coating and the second adhesive coating.

The exposing of the stack of lenses to the electron beam may be performed while the stack of lenses is on roll-to-roll processing equipment. A temperature of the heating of the second adhesive coating may be greater than a temperature of the heating of the first adhesive coating. An exposure time of the exposing of the second adhesive coating to ultraviolet light may be greater than an exposure time of the exposing of the first adhesive coating to ultraviolet light. After the heating of the second adhesive coating, a thickness of the first adhesive coating may be 20 microns or less and a thickness of the second adhesive coating may be 20 microns or less. After the heating of the second adhesive coating, a thickness variation of the first adhesive coating may be less than 0.5 microns in a 12-millimeter period and a thickness variation of the second adhesive coating may be less than 0.5 microns in a 12-millimeter period. Each of the first, second, and third lenses may comprise polyethylene terephthalate (PET). Each of the first and second adhesive coatings may comprise an optically clear adhesive (OCA). Each of the first and second adhesive coatings may comprise an acrylate.

The method may comprise additional steps after the laminating of the third lens onto the surface of the second adhesive coating and prior to the exposing of the stack of lenses to the electron beam. The additional steps may comprise coating the third lens with a third adhesive coating (e.g., comprising at least 30% solvent), heating the third adhesive coating to evaporate at least some solvent of the third adhesive coating and to initiate curing of the third adhesive coating, and after the heating of the third adhesive coating, exposing the third adhesive coating to ultraviolet light to continue curing of the third adhesive coating. The additional steps may further comprise, after the exposing of the third adhesive coating to ultraviolet light, laminating a fourth lens onto a surface of the third adhesive coating to add the fourth lens to the stack of lenses. The exposing of the stack of lenses to the electron beam may further be to continue curing of the third adhesive coating.

In some cases, the third and fourth lenses may already be adhered together before the third lens is laminated onto the surface of the second adhesive. That is, two stacks of two (or more) lenses may be combined together. In this regard, another aspect of the embodiments of the present disclosure is a method of manufacturing a stack of peelable lenses in which the method may include coating a first lens with a first adhesive coating (e.g., comprising at least 30% solvent), heating the first adhesive coating to evaporate at least some solvent of the first adhesive coating and to initiate curing of the first adhesive coating, and, after the heating of the first adhesive coating, exposing the first adhesive coating to ultraviolet light to continue curing of the first adhesive coating. The method may further comprise, after the exposing of the first adhesive coating to ultraviolet light, laminating a second lens onto a surface of the first adhesive coating to produce a first stack of lenses. The method may further comprise coating a third lens with a third adhesive coating (e.g., comprising at least 30% solvent), heating the third adhesive coating to evaporate at least some solvent of the third adhesive coating and to initiate curing of the third adhesive coating, and, after the heating of the third adhesive coating, exposing the third adhesive coating to ultraviolet light to continue curing of the third adhesive coating. The method may further comprise, after the exposing of the third adhesive coating to ultraviolet light, laminating a fourth lens onto a surface of the third adhesive coating to produce a second stack of lenses. The method may further comprise coating the second lens with a second adhesive coating (e.g., comprising at least 30% solvent), heating the second adhesive coating to evaporate at least some solvent of the second adhesive coating and to initiate curing of the second adhesive coating, and, after the heating of the second adhesive coating, exposing the second adhesive coating to ultraviolet light to continue curing of the second adhesive coating. The method may further comprise, after the exposing of the second adhesive coating to ultraviolet light, laminating the second stack of lenses onto a surface of the second adhesive coating to produce a combined stack of lenses from the first and second stacks of lenses. The method may further comprise exposing the combined stack of lenses to an electron beam to continue curing of the first adhesive coating, the second adhesive coating, and the third adhesive coating.

The exposing of the combined stack of lenses to the electron beam may be performed while the combined stack of lenses is on roll-to-roll processing equipment. A temperature of the heating of the second adhesive coating may be greater than a temperature of the heating of the first adhesive coating (e.g., by 20%). An exposure time of the exposing of the second adhesive coating to ultraviolet light may be greater than an exposure time of the exposing of the first adhesive coating to ultraviolet light (e.g., by 50%). After the heating of the second adhesive coating, a thickness of the first adhesive coating may be 20 microns or less and a thickness of the second adhesive coating may be 20 microns or less. After the heating of the second adhesive coating, a thickness variation of the first adhesive coating may be less than 0.5 microns in a 12-millimeter period and a thickness variation of the second adhesive coating may be less than 0.5 microns in a 12-millimeter period, resulting in reduced optical distortion. Each of the first, second, third, and fourth lenses may comprise polyethylene terephthalate (PET). Each of the first, second, and third adhesive coatings may comprise an optically clear adhesive (OCA). Each of the first, second, and third adhesive coatings may comprise an acrylate.

More generally in regard to combining stacks of two or more lenses together, another aspect of the embodiments of the present disclosure may include a method of manufacturing a stack of peelable lenses in which the method comprises producing first and second stacks of lenses. The producing of the first stack may include providing a lens and performing the following sequence of steps one or more times, with the lens initially defining an outermost lens of the first stack: coating the outermost lens of the first stack with an adhesive coating (e.g., comprising at least 30% solvent), heating the adhesive coating to evaporate at least some solvent of the adhesive coating and to initiate curing of the adhesive coating, exposing the adhesive coating to ultraviolet light to continue curing of the adhesive coating, and laminating an additional lens onto a surface of the adhesive coating, the additional lens redefining the outermost lens of the first stack. Similarly, the producing of the second stack may include providing a lens and performing the following sequence of steps one or more times, with the lens initially defining an outermost lens of the second stack: coating the outermost lens of the second stack with an adhesive coating (e.g., comprising at least 30% solvent), heating the adhesive coating to evaporate at least some solvent of the adhesive coating and to initiate curing of the adhesive coating, exposing the adhesive coating to ultraviolet light to continue curing of the adhesive coating, and laminating an additional lens onto a surface of the adhesive coating, the additional lens redefining the outermost lens of the second stack. The method may further comprise coating the outermost lens of the first stack with an adhesive coating (e.g., comprising at least 30% solvent), heating the adhesive coating that is coated on the outermost lens of the first stack to evaporate at least some solvent of the adhesive coating and to initiate curing of the adhesive coating, and, after the heating of the adhesive coating that is coated on the outermost lens of the first stack, exposing the adhesive coating to ultraviolet light to continue curing of the adhesive coating. The method may further comprise, after the exposing of the adhesive coating that is coated on the outermost lens of the first stack, laminating the second stack of lenses onto a surface of the adhesive coating to combine the first and second stacks into a combined stack of lenses. The method may further comprise exposing the combined stack of lenses to an electron beam to continue curing of the adhesive coatings contained within the combined stack of lenses.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an example operational flow for manufacturing a stack of peelable lenses according to an embodiment of the present disclosure; and

FIG. 2 is an example sub-operational flow that may represent sub-steps of either or both of steps 110 and 120 in FIG. 1.

### DETAILED DESCRIPTION

The present disclosure encompasses various embodiments of methods of manufacturing a stack of peelable lenses, in particular, a stack that may exhibit low peel creep. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that relational terms such as first and second and the like are used solely to distinguish one from another entity without necessarily requiring or implying any actual such relationship in order between such entities.

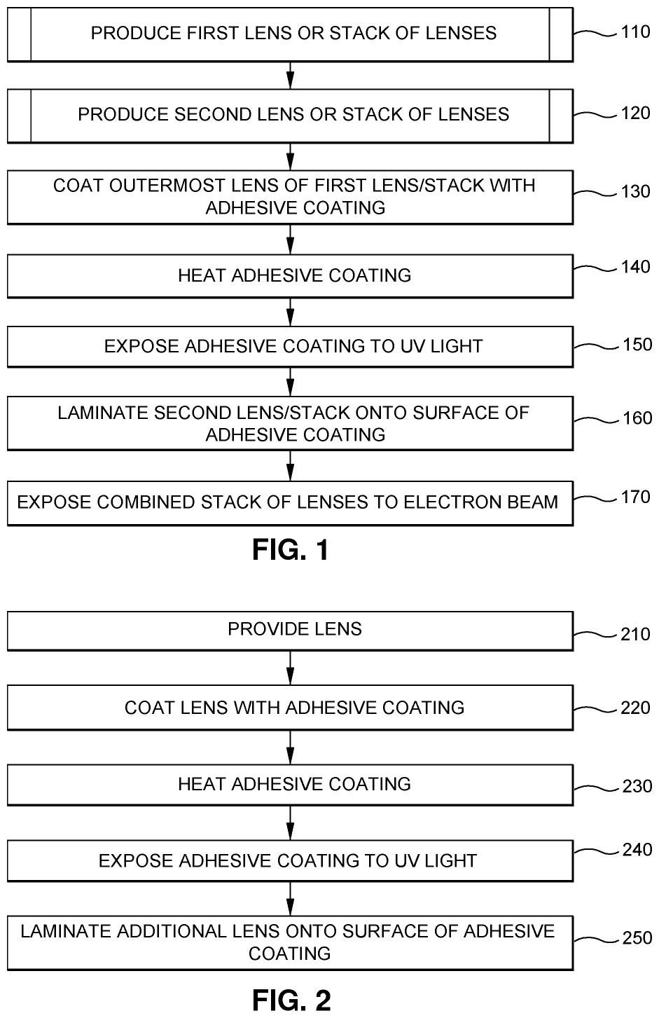

FIG. 1 is an example operational flow for manufacturing a stack of peelable lenses according to an embodiment of the present disclosure. Unlike conventional processes, the operational flow of FIG. 1 includes a final step of exposing the stack of lenses to an electron beam in order to force crosslinking to occur and complete the curing processes in all of the layers of the stack. As a result, under-curing may be avoided and peel creep may be greatly reduced. Advantageously, the electron beam exposure may simultaneously provide sterilization of any micro-organisms trapped between the laminated layers of the stack, making later radiation sterilization unnecessary.

The stack of peelable lenses may serve as or be affixed to protective eyewear such as goggles, glasses, or facemasks for off-road vehicle use or surgical and other medical procedures. Display screens of mobile phones, personal computers, ATMs and vending terminals, etc. may likewise employ stacks of peelable lenses to prevent damage to the underlying screen or block side viewing (e.g., for privacy and security in public places). In other cases, the stack of peelable lenses may serve as or be affixed to a larger size window of building or a vehicle windshield for tinting (e.g., for privacy), for thermal insulation, to block ultraviolet (UV) radiation, or for decoration. In any such setting, as the outermost lens of the stack becomes dirty and obstructs the wearer's or operator's vision, it may be peeled away to reveal the next pristine lens underneath. Examples of stacks of peelable lenses that may be manufactured as described herein, as well as methods of manufacturing and installation that may be used together with the processes described herein, may include those described in U.S. Pat. No. 8,361,260, entitled “Automobiles having a Radiant Barrier,” U.S. Pat. Nos. 9,128,545, 9,274,625, and 10,620,670, all entitled “Touch Screen Shield,” U.S. Pat. No. 9,295,297, entitled “Adhesive Mountable Stack of Removable Layers,” U.S. Patent Application Pub. No. 2020/0124768, entitled “Transparent Covering Having Anti-Reflective Coatings,” U.S. Patent Application Pub. No. 2020/0247102, entitled “Thermoform Windshield Stack with Integrated Formable Mold,” U.S. Pat. No. 11,364,715, entitled “Polymer Safety Glazing for Vehicles,” U.S. Patent Application Pub. No. 2021/0070017, entitled “Nano Particle Solar Control Film,” U.S. Patent Application Pub. Nos. 2021/0162645 and 2022/0032591, both entitled “Method and Apparatus for Reducing Non-Normal Incidence Distortion in Glazing Films,” U.S. Patent Application Pub. No. 2021/0283994, entitled “Protective Barrier for Safety Glazing,” U.S. Patent Application Pub. No. 2022/0040956, entitled “Protective Barrier for Surfaces,” U.S. patent application Ser. No. 17/210,241, entitled “Tearoff Tab Tensioner,” U.S. patent application Ser. No. 17/342,373, entitled “Low Haze UV Blocking Removable Lens Stack,” U.S. Pat. No. 11,307,329, entitled “Low Reflectance Removable Lens Stack,” and U.S. Pat. No. 10,427,385, entitled “Low Reflectance Optical Web,” the entire contents of each of which is incorporated by reference herein.

The operational flow of FIG. 1 may begin with producing first and second lenses or stacks of lenses (steps 110, 120). In the simplest case of manufacturing only a two-layer stack, steps 110 and 120 may each only produce a single lens, for example, which may thereafter be combined according to steps 130-170. In the case of manufacturing a stack of three or more lenses, one or both of steps 110 and 120 may itself produce a stack of lenses (which will be a sub-stack of the final stack of lenses produced by steps 130-170).

By way of illustration, a stack of three lenses may be manufactured according to the operational flow of FIG. 1 as follows. The operational flow may begin with producing a first stack of two lenses (step 110). For example, referring to the sub-operational flow of FIG. 2, step 110 may begin with providing a first lens (step 210), such as a polyethylene terephthalate (PET) lens or other optically clear substrate, which may be provided as a roll-to-roll processing web. The first lens may be 25-400 microns thick, for example. The first lens may be coated with a first adhesive coating (step 220) comprising a laminating adhesive such as an optically clear adhesive (OCA), which may be in the family of pressure sensitive adhesives (PSAs). To meet criteria for high transmission, low haze, and low distortion, a very thin coating of the laminating adhesive on the order of 10-20 microns (or even 5-20 microns) may be preferred, especially given that optical error such as haze and distortion is additive with each layer added to the stack. To this end, the adhesive coating may comprise a high content of solvent to solids such as at least 30% solvent. In order to produce a thin PSA, for example, 30%-60% solvents may be mixed into acrylates to reduce the viscosity of the liquid and may be deposited onto the first lens via gravure, rods, or slot dies in a roll-to-roll process. The surface of the first lens may be nano-roughened to promote a high peel strength of the PSA so that when the first lens is peeled away from the next laminated lens the PSA stays permanently affixed to the first lens surface.

The coated first lens may then pass through several curing stages. For example, as shown in FIG. 2, the adhesive coating may first be heated (e.g., by one or more ovens at 150-220° F.) to evaporate at least some of the solvent (step 230). This may reduce the thickness by 40%-70% and may allow the coating to level out to have a consistent thickness, minimizing optical distortion. After heating (or after a later heating step, as the effects may be cumulative), the thickness of the adhesive coating may be 20 microns or less (e.g., 5-20 microns) and the thickness variation may be less than 0.5 microns in a 12-millimeter period across the web, for example. The heating may also initiate curing of the first adhesive coating as some crosslinking may begin to occur at this point. Next, the adhesive coating may be exposed to ultraviolet (UV) light (e.g., 0.1-1.0 Mj/m²) to continue curing of the adhesive coating (step 240), for example, by starting photoinitiation of the crosslinking process.

With the first adhesive coating in this partially cured state, the operational flow may continue with laminating an additional lens onto the surface of the partially cured adhesive coating (step 250), for example, by a nipping roller. At this stage, the subprocess of FIG. 2 has produced a stack of two lenses, which will serve as the first stack of lenses produced by step 110 of FIG. 1.

The operational flow of FIG. 1 may then continue with producing a second lens or stack (step 120), which may be simply a single lens in the case of manufacturing a three-layer stack. In this regard, the operational flow of FIG. 2 may begin again, this time as a subprocess of step 120. Since only one lens will be produced in this step, the lens may simply be provided in step 210, with steps 220-250 omitted. Thus, in the relatively simple example of a three-layer stack, a two-layer stack may be produced by step 110 while a single lens is produced by step 120. The operational flow of FIG. 1 may then proceed with coating the outermost lens of the first stack (produced by step 110) with an adhesive coating (step 130). In this case, the outermost lens of the first stack may be the additional lens that was laminated onto the first lens in step 250 during the sub-operational flow of step 110. The adhesive coating (second adhesive coating) may be the same as described above and may likewise be heated (step 140) and exposed to UV light (step 150). The single lens produced by step 120 may then be laminated onto the surface of the partially cured second adhesive coating to add a third lens to the stack of lenses (step 160), for example, by a nipping roller.

Unlike conventional processes of manufacturing stacks of peelable lenses, the operational flow of FIG. 1 may conclude with exposing the entire combined stack of lenses to an electron beam to continue curing of the adhesive coatings contained within (step 170), namely, the first and second adhesive coatings in the example of a three-layer stack. The electron beam exposure may preferably be performed while the stack of lenses is still on roll-to-roll processing equipment that was used to assemble it. Advantageously, the electron beam exposure may complete the curing function equally in all layers of the stack. Since the stack is relatively thin (e.g., 10-25 mils) the electron beam exposure may be very uniform from top to bottom of the stack. If UV absorbing compounds are present in the adhesive coating (e.g., to improve weatherability) the electron beam may still provide a uniform exposure, unlike what is found to be the case with UV exposure processes in the presence of UV absorbing compounds.

It can be appreciated that the processing time for each adhesive layer may be different as each added layer undergoes fewer heating and UV processes than those before it. As described above, the electron beam curing may help to even out the curing between the layers by completing the curing function in the entire stack. It is also contemplated that the uniformity of curing may be further enhanced by varying the curing processes throughout the operational flow of FIG. 1. For example, temperatures of later heating processes (e.g., step 140) may be greater than temperatures of earlier heating processes (e.g., step 230). That is, using the above three-layer stack as an example, the temperature of the heating of the second adhesive coating may be greater than the temperature of heating the first adhesive coating. Instead, or additionally, exposure times of later UV exposure processes (e.g., step 150) may be greater than exposure times of earlier UV exposure processes (e.g., step 240). For example, continuing with the above three-layer example, the exposure time of exposing the second adhesive coating to UV light may be greater than the exposure time of exposing the first adhesive coating to UV light. In this way, the greater temperature and/or longer UV exposure experienced by later adhesive coatings can help the later adhesive coatings “catch up” with the curing of the earlier adhesive coatings that have already undergone some heating and/or UV exposure. By modifying the thermal and UV curing at each layer, a more uniform partial curing can be achieved before the entire stack is exposed to the final curing of the electron beam (step 170) in order to more precisely meet the target peel strength at each layer of the stack.

Along the same lines, it should be noted, in general, that the thermal and UV cure times and other parameters may be selected in consideration of the later electron beam curing. In particular, the thermal and UV curing may be less than in conventional manufacturing processes in order that the electron beam curing does not over-cure the stack and increase the peel strength too much. In general, the electron beam curing may adjust the peel strength of the adhesive coatings toward a target peel strength, with the prior thermal and UV curing thus being aimed only to begin the curing process but not to reach the target peel strength.

As a further outcome of exposing the stack of lenses to the electron beam while it is still in the roll-to-roll processing, the electron beam exposure may also provide sterilization of any microorganisms trapped between the laminated layers of the stack, thus ensuring a sterile lens stack. This greatly increases the efficiency of the manufacturing process as compared to first cutting desired shapes out of the rolls (e.g., eyewear lens shapes) and then shipping them to a lab for gamma sterilization of the interlayers, for example. In this regard, it should be noted that electron beam exposure would typically not be used for this kind of downstream sterilization because it would be unknown if the peel strength might be affected by further crosslinking of the adhesive.

In the above example, a stack of three lenses was manufactured according to the operational flow of FIG. 1, with step 110 producing a sub-stack of two lenses (by performing steps 210-250) and step 120 producing a single lens (by performing only step 210). If a stack of four lenses, five lenses, or more is desired, the operational flow of FIG. 1 may be performed in essentially the same way but with steps 220-250 repeated as desired during step 110, with each new adhesive coating being successively applied to each additional lens. So, for example, a stack of four lenses may be manufactured according to the operational flow of FIG. 1 as follows. First a stack of three lenses may be produced (step 110), referring to the sub-operational flow of FIG. 2, by providing a first lens (step 210), coating the first lens with a first adhesive coating (step 220), heating the first adhesive coating to evaporate at least some of the solvent (step 230), exposing the first adhesive coating to UV light to continue curing of the first adhesive coating (step 240), laminating a second lens onto the surface of the first adhesive coating (step 250), coating the second lens with a second adhesive coating (step 220 again), heating the second adhesive coating to evaporate at least some of the solvent (step 230 again), exposing the second adhesive coating to UV light to continue curing of the second adhesive coating (step 240 again), and laminating a third lens onto the surface of the first adhesive coating (step 250 again). The operational flow of FIG. 1 may then continue with producing a single lens as described above (step 120, consisting only of the subprocess of step 210), followed by coating the outermost lens of the first stack (produced by step 110) with a third adhesive coating (step 130), heating and exposing the third adhesive coating to UV light (steps 140 and 150), laminating the single lens produced by step 120 onto the surface of the partially cured third adhesive coating to add a fourth lens to the stack of lenses (step 160), and, finally, exposing the combined stack of lenses to an electron beam (step 170). Larger stacks can be produced simply by repeating steps 220-250 additional times during step 110.

The stack of lenses may also be manufactured by combining two sub-stacks of two or more lenses each (e.g., a two-by-two stack, a two-by-three stack, etc.). To illustrate this, another way of manufacturing a stack of four lenses according to the operational flow of FIG. 1 is as follows. First a stack of two lenses may be produced (step 110), referring to the sub-operational flow of FIG. 2, by performing steps 210-250 one time through without repeating steps 220-250. Then, a second stack of two lenses may be produced (step 120) in exactly the same way, that is, by performing steps 210-250 one time through without repeating steps 220-250. The operational flow of FIG. 1 may then continue with coating the outermost lens of the first sub-stack of two lenses (produced by step 110) with an adhesive coating (step 130), heating and exposing the adhesive coating to UV light (steps 140 and 150), laminating the second sub-stack of two lenses (produced by step 120) onto the surface of the partially cured adhesive coating to combine the two sub-stacks into a stack of four lenses (step 160), and, finally, exposing the combined stack of lenses to an electron beam (step 170). Larger stacks of this type can be produced simply by repeating steps 220-250 additional times during either or both of steps 110 and 120.

In a case where one or both of steps 110 and 120 involve the repetition of steps 220-250 of FIG. 2, each successive repetition of the heating and UV exposure processes (steps 230 and 240) may have different parameters in order to achieve a more even partial curing as described above. Thus, for example, an earlier repetition of step 230 may be at a lower temperature, a later repetition of step 230 may be at a higher temperature, and the final heating in step 140 may be at the highest temperature. Similarly, an earlier repetition of step 240 may have a shorter UV exposure time, a later repetition of step 240 may have a longer UV exposure time, and the final UV exposure in step 150 may have the longest UV exposure time. In this way, a more uniform partial curing can be achieved before the entire stack is exposed to the final curing of the electron beam (step 170) in order to more precisely meet the target peel strength at each layer of the stack.

It should be noted that, in general, any of the above processes and sub-process may be repeated until the desired number of lenses are laminated into a peelable stack. In some cases, sub-stacks may be combined to form stacks that are themselves sub-stacks to be combined into larger stacks. For example, one possible process may be to combine two stacks of two lenses each and then to combine the resulting stack of four lenses with another stack of four lenses to produce a stack of eight lenses. The resulting combined stack may then be exposed to the electron beam (step 170) in order to complete the curing process in all adhesive coatings contained within.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1-21. (canceled)

22. A method of manufacturing a stack of peelable lenses, the method comprising:
coating a first lens with a first adhesive coating;
heating the first adhesive coating to evaporate at least some solvent of the first adhesive coating and to initiate curing of the first adhesive coating;
after said heating the first adhesive coating, exposing the first adhesive coating to ultraviolet light to continue curing of the first adhesive coating;
after said exposing the first adhesive coating to ultraviolet light, laminating a second lens onto a surface of the first adhesive coating to produce a stack of lenses;
coating the second lens with a second adhesive coating;
heating the second adhesive coating to evaporate at least some solvent of the second adhesive coating and to initiate curing of the second adhesive coating;
after said heating the second adhesive coating, exposing the second adhesive coating to ultraviolet light to continue curing of the second adhesive coating, wherein parameters of the heating and the exposing of the first and second adhesive coatings are selected such that the first and second adhesive coatings are only partially cured to result in respective peel strengths that are less than respective target peel strengths;
after said exposing the second adhesive coating to ultraviolet light, laminating a third lens onto a surface of the second adhesive coating to add the third lens to the stack of lenses; and,
after said laminating the third lens onto the surface of the second adhesive coating, exposing the stack of lenses to an electron beam to sterilize the stack of lenses and to continue curing of the first adhesive coating and the second adhesive coating.

23. The method of claim 22, wherein said exposing the stack of lenses to the electron beam is performed while the stack of lenses is on roll-to-roll processing equipment.

24. The method of claim 22, wherein a temperature of said heating the second adhesive coating is greater than a temperature of said heating the first adhesive coating.

25. The method of claim 22, wherein an exposure time of said exposing the second adhesive coating to ultraviolet light is greater than an exposure time of said exposing the first adhesive coating to ultraviolet light.

26. The method of claim 22, wherein, after said heating the second adhesive coating, a thickness of the first adhesive coating is 20 microns or less and a thickness of the second adhesive coating is 20 microns or less.

27. The method of claim 22, wherein, after said heating the second adhesive coating, a thickness variation of the first adhesive coating is less than 0.5 microns in a 12-millimeter period and a thickness variation of the second adhesive coating is less than 0.5 microns in a 12-millimeter period.

28. The method of claim 22, wherein each of the first, second, and third lenses comprises polyethylene terephthalate (PET).

29. The method of claim 22, wherein each of the first and second adhesive coatings comprises an optically clear adhesive (OCA).

30. The method of claim 22, wherein each of the first and second adhesive coatings comprises an acrylate.

31. The method of claim 22, further comprising, after said laminating the third lens onto the surface of the second adhesive coating and prior to said exposing the stack of lenses to the electron beam:
coating the third lens with a third adhesive coating;
heating the third adhesive coating to evaporate at least some solvent of the third adhesive coating and to initiate curing of the third adhesive coating;
after said heating the third adhesive coating, exposing the third adhesive coating to ultraviolet light to continue curing of the third adhesive coating; and,
after said exposing the third adhesive coating to ultraviolet light, laminating a fourth lens onto a surface of the third adhesive coating to add the fourth lens to the stack of lenses,
wherein said exposing the stack of lenses to the electron beam is further to continue curing of the third adhesive coating.

32. A method of manufacturing a stack of peelable lenses to have a target peel strength, the method comprising:
coating a first lens with a first adhesive coating;
heating the first adhesive coating to evaporate at least some solvent of the first adhesive coating and to initiate curing of the first adhesive coating;
after said heating the first adhesive coating, exposing the first adhesive coating to ultraviolet light to continue curing of the first adhesive coating;
after said exposing the first adhesive coating to ultraviolet light, laminating a second lens onto a surface of the first adhesive coating to produce a first stack of lenses;
coating a third lens with a third adhesive coating;
heating the third adhesive coating to evaporate at least some solvent of the third adhesive coating and to initiate curing of the third adhesive coating;
after said heating the third adhesive coating, exposing the third adhesive coating to ultraviolet light to continue curing of the third adhesive coating;
after said exposing the third adhesive coating to ultraviolet light, laminating a fourth lens onto a surface of the third adhesive coating to produce a second stack of lenses;
coating the second lens with a second adhesive coating;
heating the second adhesive coating to evaporate at least some solvent of the second adhesive coating and to initiate curing of the second adhesive coating;
after said heating the second adhesive coating, exposing the second adhesive coating to ultraviolet light to continue curing of the second adhesive coating, wherein parameters of the heating and the exposing of the first, second, and third adhesive coatings are selected such that the first, second, and third adhesive coatings are only partially cured to result in respective peel strengths that are less than respective target peel strengths;
after said exposing the second adhesive coating to ultraviolet light, laminating the second stack of lenses onto a surface of the second adhesive coating to produce a combined stack of lenses from the first and second stacks of lenses; and
exposing the combined stack of lenses to an electron beam to sterilize the combined stack of lenses and to continue curing of the first adhesive coating, the second adhesive coating, and the third adhesive coating.

33. The method of claim 32, wherein said exposing the combined stack of lenses to the electron beam is performed while the combined stack of lenses is on roll-to-roll processing equipment.

34. The method of claim 32, wherein a temperature of said heating the second adhesive coating is greater than a temperature of said heating the first adhesive coating.

35. The method of claim 32, wherein an exposure time of said exposing the second adhesive coating to ultraviolet light is greater than an exposure time of said exposing the first adhesive coating to ultraviolet light.

36. The method of claim 32, wherein, after said heating the second adhesive coating, a thickness of the first adhesive coating is 20 microns or less and a thickness of the second adhesive coating is 20 microns or less.

37. The method of claim 32, wherein, after said heating the second adhesive coating, a thickness variation of the first adhesive coating is less than 0.5 microns in a 12-millimeter period and a thickness variation of the second adhesive coating is less than 0.5 microns in a 12-millimeter period.

38. The method of claim 32, wherein each of the first, second, third, and fourth lenses comprises polyethylene terephthalate (PET).

39. The method of claim 32, wherein each of the first, second, and third adhesive coatings comprises an optically clear adhesive (OCA).

40. The method of claim 32, wherein each of the first, second, and third adhesive coatings comprises an acrylate.

41. A method of manufacturing a stack of peelable lenses, the method comprising:
producing a first stack of lenses, said producing the first stack including:
providing a lens, the lens initially defining an outermost lens of the first stack; and
performing the following sequence of steps one or more times:
coating the outermost lens of the first stack with an adhesive coating;
heating the adhesive coating to evaporate at least some solvent of the adhesive coating and to initiate curing of the adhesive coating;
exposing the adhesive coating to ultraviolet light to continue curing of the adhesive coating; and
laminating an additional lens onto a surface of the adhesive coating, the additional lens redefining the outermost lens of the first stack;
producing a second stack of lenses, said producing the second stack including:
providing a lens, the lens initially defining an outermost lens of the second stack; and
performing the following sequence of steps one or more times:
coating the outermost lens of the second stack with an adhesive coating;
heating the adhesive coating to evaporate at least some solvent of the adhesive coating and to initiate curing of the adhesive coating;
exposing the adhesive coating to ultraviolet light to continue curing of the adhesive coating; and
laminating an additional lens onto a surface of the adhesive coating, the additional lens redefining the outermost lens of the second stack;
coating the outermost lens of the first stack with an adhesive coating;
heating the adhesive coating that is coated on the outermost lens of the first stack to evaporate at least some solvent of the adhesive coating and to initiate curing of the adhesive coating;
after said heating the adhesive coating that is coated on the outermost lens of the first stack, exposing the adhesive coating to ultraviolet light to continue curing of the adhesive coating, wherein parameters of the heating and the exposing of the adhesive coatings are selected such that the adhesive coatings are only partially cured to result in respective peel strengths that are less than respective target peel strengths;
after said exposing the adhesive coating that is coated on the outermost lens of the first stack, laminating the second stack of lenses onto a surface of the adhesive coating to combine the first and second stacks into a combined stack of lenses; and
exposing the combined stack of lenses to an electron beam to sterilize the combined stack of lenses and to continue curing of the adhesive coatings contained within the combined stack of lenses.

42. A method of manufacturing a stack of peelable lenses to have a target peel strength, the method comprising:
providing a stack of lenses with adhesive coatings disposed between each pair of adjacent lenses of the stack, wherein the adhesive coatings are only partially cured to result in respective peel strengths that are less than respective target peel strengths; and
exposing the stack of lenses to an electron beam to simultaneously adjust the respective peel strengths of the adhesive coatings toward the respective target peel strength and sterilize the stack of lenses.
